(19) United States
(12) Patent Application Publication
(10) Pub. No.: US 2011/0072994 A1
(43) Pub. Date: Mar. 31, 2011

(54) SHEET DRYER

(75) Inventors: Hiroyuki SUGIYAMA, Tokyo (JP); Kazuhiro Maejima, Tsukuba-shi (JP)

(73) Assignee: KOMORI CORPORATION, Tokyo (JP)

(21) Appl. No.: 12/891,363

(22) Filed: Sep. 27, 2010

(30) Foreign Application Priority Data
Sep. 28, 2009 (JP) 2009-222111

(51) Int. Cl. B41F 35/00

(52) U.S. Cl. 101/424.1

(57) ABSTRACT

A sheet dryer includes: a coating section 10 which includes a single coating unit coating a paper sheet W transported by a transport part with a UV varnish; a first chain conveyor 20 which does not have a guide surface coming into contact with the UV-varnish coated surface of the paper sheet W passed over from the coating section 10, and which has a transport distance L2 longer than a transport distance L1 of the single coating unit; a transport cylinder 22 which transports the paper sheet W passed over from the first chain conveyor 20; and an LED-UV drying device 30 which is disposed in the vicinity of the transport cylinder 22, faces the UV-varnish coated surface of the paper sheet W held by the transport cylinder 22, and cures the UV varnish on the paper sheet W.

### TECHNICAL FIELD

The present invention relates to a sheet dryer for drying a sheet which is printed with an ultraviolet (UV) ink or coated with a UV varnish.

### BACKGROUND ART

As sheet dryers of this type, lamp-type UV dryers (hereinafter, simply referred to as UV lamps) which emit UV light (ultraviolet rays) to instantly cure and dry a UV ink or UV varnish have been well known as disclosed in Patent Literatures 1 to 3 and the like.

However, these conventional UV lamps have problems of: (1) large power consumption, which causes a high electricity cost; (2) a large amount of heat generated due to the inclusion of infrared rays (IR light), which causes a large influence of heat on printing materials and printing presses; (3) generation of ozone odor, which requires duct installation for releasing it; (4) a short life, which imposes a large burden of maintenance; and the like.

To solve these problems, in recent years, LED-UV drying devices (systems) have been developed which use light emitting diodes (LEDs) as their light sources, instead of conventional UV lamps. The LED-UV drying devices not only reduce power consumption to a large extent but also have many excellent features that may solve the problems mentioned above. Specifically, the LED-UV drying devices do not produce ozone, which would otherwise be produced if a UV lamp is used, and therefore require no exhaust duct. Thus, they are environmentally friendly. Moreover, the LED-UV drying devices bring about such advantages that: no duct installation is required, which makes incidental facilities compact; the amount of heat generated is small, which reduces the influence of heat on printing materials and the printing press; the light source can be turned on and off instantly, which shortens the waiting time for operation; the light source has a long life, which reduces the burden of maintenance.

{Citation List}

{Patent Literatures}

{Patent Literature 1} Japanese Patent Application Publication No. 2007-21831

{Patent Literature 2} Japanese Patent Application Publication No. 2004-291335

{Patent Literature 3} Japanese Patent Application Publication No. 2003-251789

### SUMMARY OF INVENTION

### Technical Problem

However, the UV rays of the LED-UV drying devices are not as strong as those of the conventional UV lamps. Hence, for example, where and how the drying devices should be mounted to their printing presses are extremely important.

For example, if a UV lamp mounted in the vicinity of an impression cylinder as described in Patent Literature 1 is replaced with an LED-UV drying device, the LED-UV drying device can be placed as close as possible to a UV-ink printed surface or to a UV-varnish coated surface. However, the mounting position is located immediately after a printing unit (or a coating unit), meaning that the UV ink or UV varnish is cured and dried without waiting a certain time period to elapse. Accordingly, the function of the LED-UV drying device cannot be fully exerted. This leads to a poor gloss and a low quality.

If UV lamps mounted to a chain conveyor as described in Patent Literature 2 are replaced with LED-UV drying devices, the UV-ink or UV-varnish can be cured and dried after the elapse of a certain time period. However, it is necessary to avoid the interference with gripper holding mechanisms of chain grippers (gripper bars of the chain grippers each of which is made up of a gripper and a gripper bar). Accordingly, there is a problem of being unable to bringing the LED-UV drying devices sufficiently close to a UV-ink printed surface or a UV-varnish coated surface.

If UV lamps as described in Patent Literature 3 are replaced with LED-UV drying devices, the following four problems will occur.

(1) A printed surface or a coated surface may be damaged due to contact of guide surfaces of transfer cylinders with the printed surface or the coated surface (FIGS. 1, 3, 6, 7, 9, 10, 11 and 12).

(2) The printed surface or the coated surface may be damaged due to contact of guide surfaces of drying cylinders or checking cylinders with the printed surface or the coated surface (FIGS. 1, 6 and 9).

(3) The gloss cannot be increased because the printed surface or the coated surface is cured immediately after the surface is printed with a UV ink or coated with a UV varnish (FIG. 5).

(4) The LED-UV drying devices must be located away from gripper bars of a running delivery chain so that the interference therewith (FIGS. 3, 7, 8 and 10) can be avoided.

With this background, an object of the present invention is to provide a sheet dryer in which an LED-UV drying device is placed at such an effective position as to secure a high gloss.

### Solution to Problem

The present invention for achieving the object provides a sheet dryer including: a liquid transfer device which includes a first transport part transporting a sheet, and a liquid transfer part transferring a UV-curable liquid onto the sheet transported by the first transport part; a second transport part which transports the sheet passed over from the first transport part and does not include a guide portion coming into contact with a transfer surface of the sheet;
a transport cylinder which transports the sheet passed over from the second transport part; and an LED-UV drying device which is disposed in a vicinity of the transport cylinder and emits an ultraviolet ray to the transfer surface of the sheet held by the transport cylinder to thereby cure the UV-curable liquid transferred onto the sheet.

The second transport part may have a longer transport distance (L2) than a transport distance (L1) of the first transport part.

The liquid transfer device may be a coating section to coat a paper sheet printed in a printing section with a UV-varnish, and include the liquid transfer part and the first transport part, the liquid transfer part being made up of a blanket cylinder, an anilox roller and a chamber coater, the first transport part being a part where a paper sheet is passed over to an impression cylinder from a last printing unit via a transfer cylinder.

The second transport part may be a first chain conveyor in which a chain is looped around paired sprockets which do not include a guide portion coming into contact with the transfer surface of the sheet, the chain including a plurality of chain grippers each made up of a gripper and a gripper bar and attached to the chain at predetermined intervals in a transport direction of the sheet.

The first chain conveyor may be placed to be raised diagonally towards a downstream side in the transport direction of the sheet.

### Advantageous Effects of Invention

With the sheet dryer according to the present invention, a sheet stays undried until a sufficient time period elapses after the transfer of a UV ink, a UV varnish or the like, and then is dried by an LED-UV drying device provided as close as possible to the transfer surface of the sheet. Accordingly, features of an LED-UV drying device can be fully exerted and at the same time, a high gloss can be secured.

### BRIEF DESCRIPTION OF DRAWINGS

FIG. 1 is a side view of a main part of a sheet-fed rotary printing press, showing Example 1 of the present invention.

FIG. 2 is a side view of a main part of a sheet-fed rotary printing press, showing Example 2 of the present invention.

### DESCRIPTION OF EMBODIMENTS

Hereinbelow, a sheet dryer according to the present invention will be described in detail by following examples and using the drawings.

### EXAMPLE 1

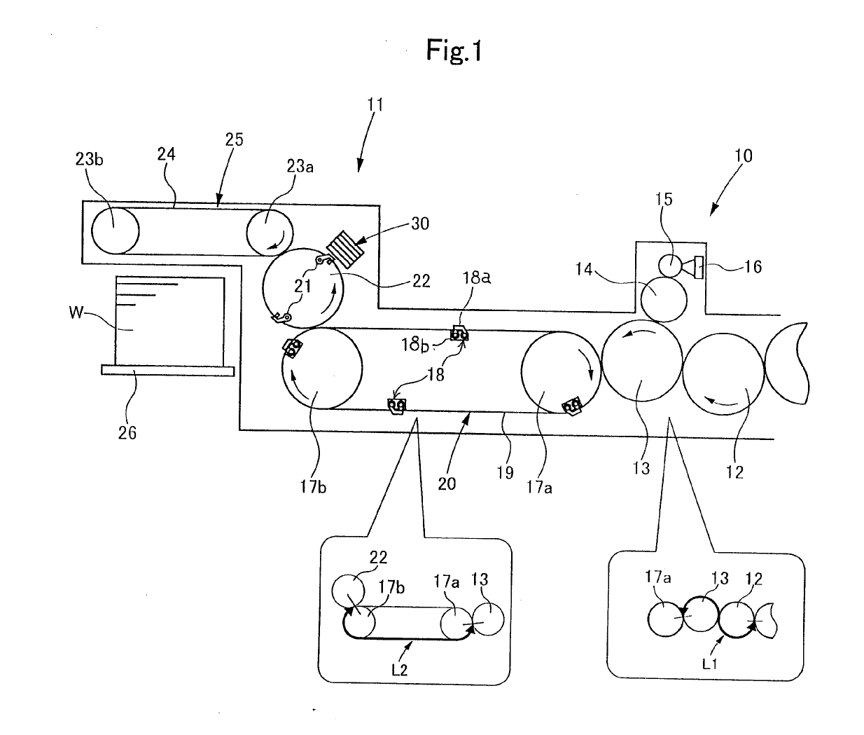

FIG. 1 is a side view of a main part of a sheet-fed rotary printing press, showing Example 1 of the present invention.

As shown in FIG. 1, the sheet-fed rotary printing press is formed mainly of: an unillustrated sheet feeding section to feed paper sheets W as sheets; an unillustrated printing section (liquid transfer device) to perform printing on each of the paper sheets W fed thereto with UV ink (UV-curable liquid) or the like; a coating section (liquid transfer device) 10 to coat (apply) the printed paper sheet W with UV varnish (UV-curable liquid); and a delivery section 11 to deliver the paper sheet W subjected to the coating treatment. The sheet-fed rotary printing press is designed to perform the printing process and the coating treatment on one surface (front surface) of the paper sheet W. The printing section is made up of multiple printing units, while the coating section 10 is made up of a single coating unit.

In the coating section 10, the single coating unit is formed of: an impression cylinder (first transport part) 13 to which a paper sheet W is passed over from the last printing unit via a transfer cylinder (first transport part) 12; a blanket cylinder (liquid transfer part) 14 in contact with the impression cylinder 13 at a position downstream of a contact point between the impression cylinder 13 and the transfer cylinder 12 in a transport direction of the paper sheet W; an anilox roller (liquid transfer part) 15 in contact with the blanket cylinder 14; and a chamber coater (liquid transfer part) 16 which supplies the varnish to the anilox roller 15. Note that the transfer cylinder 12 and the impression cylinder 13 have guide surfaces (guide portions) for the paper sheet W.

Thus, the varnish supplied from the chamber coater 16 to the anilox roller 15 is transferred to the blanket cylinder 14 and then applied onto the one surface (front surface) of the printed paper sheet W passing a contact point between the blanket cylinder 14 and the impression cylinder 13.

The delivery section 11 includes: a first chain conveyor (second transport part) 20 and a second chain conveyor 25 situated in an upper-lower positional relation; a transport cylinder (drying cylinder) 22 interposed between the first and second chain conveyors 20 and 25; and a product pile 26 placed below the second chain conveyor 25. In addition, an LED-UV drying device 30 is disposed in the vicinity of the transport cylinder 22 while facing the transfer surface of the paper sheet W.

The first chain conveyor 20 is formed by looping a delivery chain 19 around paired sprockets 17a and 17b which do not include guide surfaces (guide portions) coming into contact with the transfer surface of the paper sheet W. The delivery chain 19 includes multiple (four in FIG. 1) chain grippers 18 each made up of a gripper 18a and a gripper bar 18b and attached to the delivery chain 19 at predetermined intervals in the transport direction of the paper sheet W. A transport distance L2 of the first chain conveyor 20 is set longer than a transport distance L1 of the single coating unit (first transport part).

Note that the transport distance L1 refers to a length obtained by adding two transport distances which the paper sheet W is transported: one is a distance from a passing point at which the paper sheet W is passed over from the cylinder right before the transfer cylinder 12 to the transfer cylinder 12, to a passing point at which the paper sheet W is passed over from the transfer cylinder 12 to the impression cylinder 13; and the other is a distance from the passing point at which the paper sheet W is passed over from the transfer cylinder 12 to the impression cylinder 13, to a passing point at which the paper sheet W is passed over from the impression cylinder 13 to the sprocket 17a (see a balloon in FIG. 1). In contrast, the transport distance L2 refers to a length which a paper sheet W is transported from the passing point at which the paper sheet W is passed over from the impression cylinder 13 to the sprocket 17a, to a passing point at which the paper sheet W is passed over from the sprocket 17b to the transport cylinder 22 (see the other balloon in FIG. 1).

The second chain conveyor 25 is formed by looping a delivery chain 24 around paired sprockets 23a and 23b. The delivery chain 24 includes unillustrated multiple chain grippers attached thereto at predetermined intervals in the transport direction of the paper sheet W.

The transport cylinder 22 includes two gripping devices 21 attached to its outer peripheral portion at point-symmetric positions. The LED-UV drying device 30 is supported at such a position as not to interfere with these gripping devices 21, on the machine frame side as appropriate. Note that the transport cylinder 22 has a guide surface (guide portion) for the paper sheet W.

Instead of conventional UV lamps, the LED-UV drying device 30 uses light emitting diodes (LEDs) as its light source. Using ultraviolet rays emitted from the LEDs, the LED-UV drying device 30 cures and dries the UV ink printed on a paper sheet W and the UV varnish applied on the paper sheet W.

According to the above configuration, a paper sheet W having been subjected to the coating treatment on its one surface (front surface) by the coating unit in the coating section 10 is transported to the first chain conveyor 20, the transport cylinder 22 and the second chain conveyor 25 in this order in the delivery section 11, and thereafter stacked on the product pile 26.

At the transport cylinder 22, the UV varnish applied on the paper sheet W is cured and dried by ultraviolet rays emitted from the LED-UV drying device 30.

Here, use of the LED-UV drying device 30 allows a significant decrease in power consumption as compared to conventional UV lamps. Use of the LED-UV drying device 30 also provides many excellent features mentioned above. Specifically, the LED-UV drying device 30 does not produce ozone, which would otherwise be produced if a UV lamp is used, and therefore requires no exhaust duct. Thus, it is environmentally friendly. Moreover, the LED-UV drying device 30 brings about such advantages that: no duct installation is required, which makes incidental facilities compact; the amount of heat generated is small, which reduces the influence of heat on printing materials and the printing press; the light source can be turned on and off instantly, which shortens the waiting time for operation; the light source has a long life, which reduces the burden of maintenance.

In addition, since the LED-UV drying device 30 is provided in the vicinity of the transport cylinder 22 to be as close as possible to the UV-varnish coated surface, an insufficient strength of UV ray, which is a downside of the LED-UV drying device 30, can be redeemed to a satisfactory extent.

Further, a paper sheet W having been subjected to the coating treatment reaches the transport cylinder 22 after travelling on the chain conveyor 20 whose transport distance L2 is set longer than the transport distance L1 of the single coating unit. Thus, after the coating treatment, the UV ink and UV varnish are given a sufficiently long time to dry. This makes it possible to secure a high gloss and thus to improve the quality. Moreover, since the first chain conveyor 20 does not have the guide surface coming into contact with the UV-varnish coated surface of a paper sheet W, no waste paper will be produced due to contamination or the like. Also, there is achieved an advantage that the cost of the first chain conveyor 20 is lower than that in a case of cylinder transportation.

### EXAMPLE 2

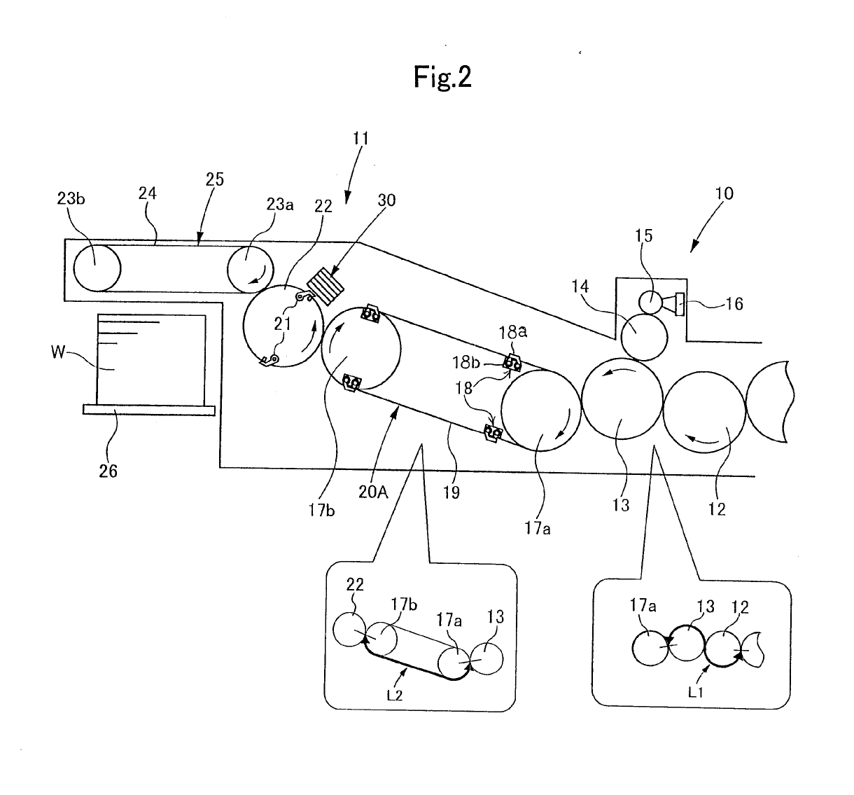

FIG. 2 is a side view of a main part of a sheet-fed rotary printing press showing Example 2 of the present invention.

Example 2 is a case where a first chain conveyor 20A similar to the one in Example 1 is placed to be raised diagonally towards a downstream side in the transport direction of a paper sheet W. The other parts of the configuration remain the same as in Example 1 and repeated description will be omitted here.

Example 2 also brings about the same advantageous effects as in Example 1.

Note that it is needless to say that the present invention is not limited to the examples described above and can be modified in various ways without departing from the gist of the present invention. For instance, it is possible to employ cylinder transportation using many skeleton cylinders having no guide surfaces as the transport part.

{Reference Signs List}
10 Coating Section
11 Delivery Section
12 Transfer Cylinder
13 Impression Cylinder
14 Blanket Cylinder
15 Anilox Roller
16 Chamber Coater
20, 20A First Chain Conveyor
22 Transport Cylinder (Drying Cylinder)
25 Second Chain Conveyor
30 Led-UV Drying Device
W Paper Sheet

1. A sheet dryer comprising:
a liquid transfer device which includes a first transport part transporting a sheet, and a liquid transfer part transferring a UV-curable liquid onto the sheet transported by the first transport part;
a second transport part which transports the sheet passed over from the first transport part and does not include a guide portion coming into contact with a transfer surface of the sheet;
a transport cylinder which transports the sheet passed over from the second transport part; and
an LED-UV drying device which is disposed in a vicinity of the transport cylinder and emits an ultraviolet ray to the transfer surface of the sheet held by the transport cylinder to thereby cure the UV-curable liquid transferred onto the sheet.

2. The sheet dryer according to claim 1, wherein the second transport part has a longer transport distance (L2) than a transport distance (L1) of the first transport part.

3. The sheet dryer according to claim 1, wherein the liquid transfer device is a coating section to coat a paper sheet printed in a printing section with a UV-varnish, and includes the liquid transfer part and the first transport part, the liquid transfer part being made up of a blanket cylinder, an anilox roller and a chamber coater, the first transport part being a part where a paper sheet is passed over to an impression cylinder from a last printing unit via a transfer cylinder.

4. The sheet dryer according to claim 1, wherein the second transport part is a first chain conveyor in which a chain is looped around paired sprockets which do not include a guide portion coming into contact with the transfer surface of the sheet, the chain including a plurality of chain grippers each made up of a gripper and a gripper bar and attached to the chain at predetermined intervals in a transport direction of the sheet.

5. The sheet dryer according to claim 4, wherein the first chain conveyor is placed to be raised diagonally towards a downstream side in the transport direction of the sheet.
